(19) United States
(12) Patent Application Publication
(10) Pub. No.: US 2014/0085223 A1
(43) Pub. Date: Mar. 27, 2014

(54) APPARATUS AND METHOD CAPABLE OF SWITCHING DISPLAYED PICTURES

(71) Applicants: HAI-SEN LIANG, Shenzhen (CN); CHIH-SAN CHIANG, New Taipei (TW); LING-JUAN JIANG, Shenzhen (CN); HUA-DONG CHENG, Shenzhen (CN)

(72) Inventors: HAI-SEN LIANG, Shenzhen (CN); CHIH-SAN CHIANG, New Taipei (TW); LING-JUAN JIANG, Shenzhen (CN); HUA-DONG CHENG, Shenzhen (CN)

(21) Appl. No.: 13/741,317

(22) Filed: Jan. 14, 2013

(30) Foreign Application Priority Data
Sep. 27, 2012 (CN) 2012103654287

(51) Int. Cl. G06F 3/01

(52) U.S. Cl. CPC G06F 3/017
USPC 345/173

(57) ABSTRACT

An apparatus capable of switching displayed pictures in response to a slide gesture by a user includes a display screen for displaying an enlarged current picture, a touch determining unit, a picture processing unit, a control unit, a time calculating unit, and a calculating unit. The picture processing unit determines a width value of the current picture and a distance between a side of the current picture and an edge of the display screen adjacent to the side. The control unit controls the picture processing unit to obtain the target picture and controls the display screen to only display the target picture if a time duration of a slide gesture from beginning to ending is equal to or greater than a predetermined time period and a ratio of the distance to the width is equal to or greater than a predetermined ratio. A related method is also provided.

### BACKGROUND

1. Technical Field

The present disclosure relates to pictures changing technology and, particularly, to an apparatus and method capable of switching displayed pictures in response to slide gestures.

2. Description of the Related Art

Mobile terminals are usually employed to display pictures. A user can drag a picture displayed on a touch display screen of the mobile terminal to a direction to change the picture to a target picture. However, if the user drags the displayed picture too quickly, more pictures than the user wants have been changed, in which condition the user has to drag the displayed picture to an opposite direction to return to the target picture, which is inconvenient for the user. Therefore, there is room for improvement within the art.

### BRIEF DESCRIPTION OF THE DRAWING

The components in the drawings are not necessarily drawn to scale, the emphasis instead being placed icon clearly illustrating the principles of the disclosure. Moreover, in the drawing, like reference numerals designate corresponding parts throughout the several views.

FIG. 1 is a diagram block of an apparatus capable of switching displayed pictures in response to slide gestures, according to an exemplary embodiment.

FIG. 2 is a schematic diagram showing a state of use of displaying a current picture enlarged on the apparatus of FIG. 1, in accordance with an exemplary embodiment.

FIG. 3 is a schematic diagram showing a state of use of dragging the current picture displayed on the apparatus of FIG. 1, in accordance with an exemplary embodiment.

FIG. 4 is a schematic diagram showing a state of use of displaying the current picture enlarged on the apparatus of FIG. 1, in accordance with an exemplary embodiment.

FIG. 5 is a flowchart of a method capable of switching displayed pictures in response to slide gestures, in accordance with an exemplary embodiment.

### DETAILED DESCRIPTION

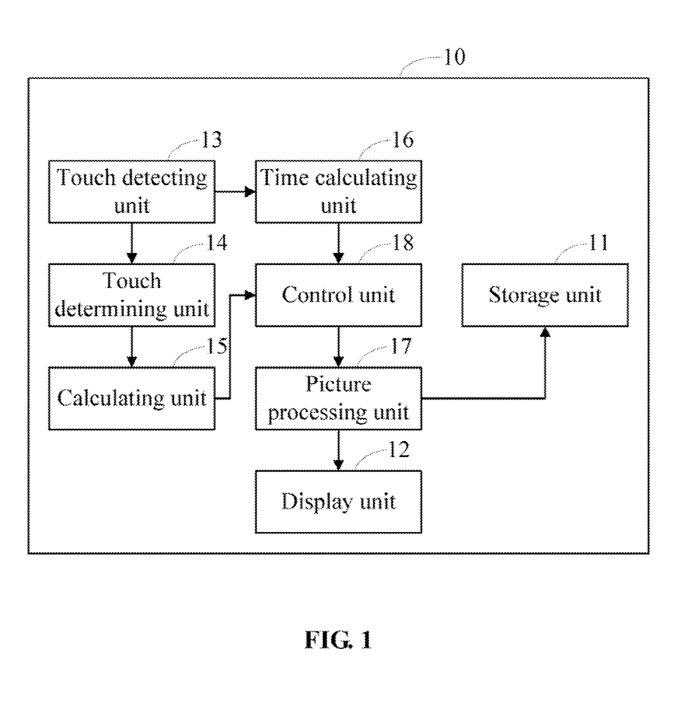

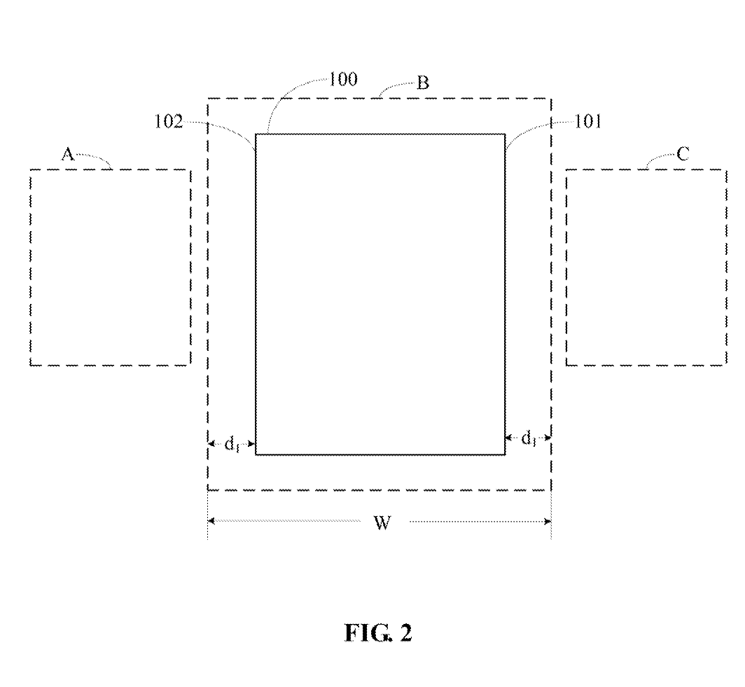

FIGS. 1 and 2 show an apparatus 10 of the embodiment. The apparatus 10 is capable of switching displayed pictures in response to slide gestures. The apparatus 10 includes a storage unit 11, a display screen 12, a touch detecting unit 13, a touch determining unit 14, a calculating unit 15, a time calculating unit 16, a picture processing unit 17, and a control unit 18. The display screen 12 is a touch display screen.

The storage unit 11 is configured for storing a plurality of pictures. The control unit 18 is configured for controlling the display screen 12 to display the plurality of pictures in a predetermined arrangement in a window 100 provided by the display screen 12. When one of the plurality of pictures displayed is touched by a finger of a user to be enlarged, the control unit 18 controls the display screen 12 to display only the current picture in the window 100. The size of the current picture labeled with capital B shown in FIG. 2 is larger than that of the window 100, which results in portion of the current picture B out of the window 100. The distance d₁ between the right side of the current picture B and a first edge 101 of the window 100 is equal to the distance d₁ between the left side of the current picture B and a second edge 102 of the window 100.

The touch detecting unit 13 is configured for detecting a slide gesture by the user on the display screen 12, and further determining a sliding direction of the detected slide gesture. The touch determining unit 14 is configured for selecting a target picture from the pictures according to the determined sliding direction. In detail, the touch determining unit 14 determines the target picture to be a picture before the current picture when the sliding direction is from left to right or from up to down. The touch determining unit 14 determines the target picture to be a picture next the current picture when the sliding direction is from right to left or from down to up. The picture processing unit 17 is configured for controlling moving the current picture on the display screen 12 along the sliding direction toward the first edge 101 of the display screen 12 in response to the slide gesture such that a portion thereof adjacent to the first edge 101 is moved out of the display screen 12, and controlling moving a portion of the target picture into the display screen 12 from the second edge 102 thereof along the sliding direction in response to the slide gesture.

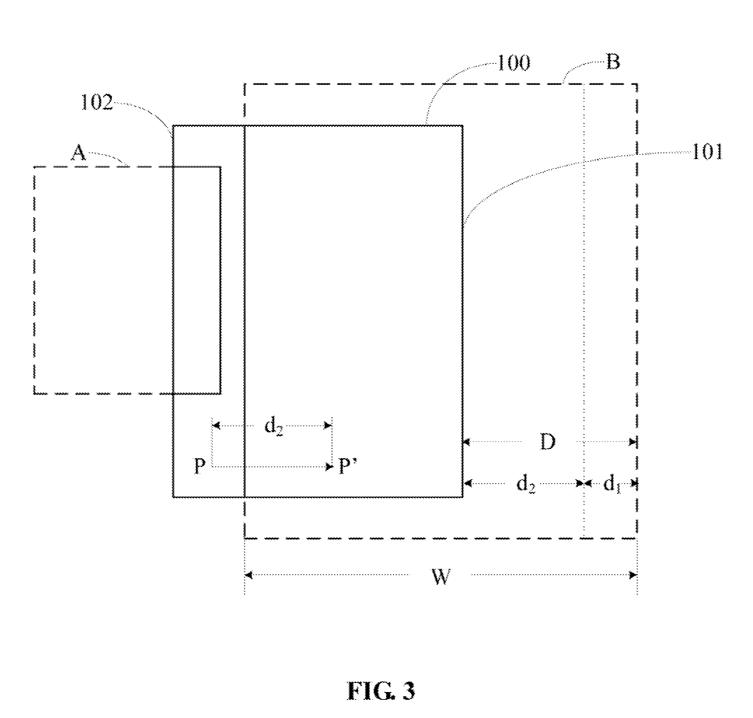

FIG. 3 shows that when the touch detecting unit 13 does not further detect any touch position after a predetermined time interval elapses, the touch determining unit 14 determines a distance d₂ between a touch beginning position P and a touch ending position P′ of a trace of the detected slide gesture. The picture processing unit 17 obtains a width value W of the current picture B, and determines a distance D between the first edge 101 of the display screen 12 and a side of the current picture B parallel with and adjacent to the first edge 101 prior to performing the slide gesture by the user. The calculating unit 15 is configured for calculating a ratio S of the distance D to the width value W.

The control unit 18 determines whether the ratio S calculated is smaller than a predetermined ratio. In the embodiment, the predetermined ratio is ½. The time calculating unit 16 is configured for calculating a time duration T of the slide gesture from the touch beginning position P to the touch ending position P′.

For example, when the target picture is the picture labeled with capital A before the current picture B, the picture processing unit 17 determines the distance D by adding the distance d₁ to the distance d₂. The calculating unit 15 calculates the ratio S between the distance D and the width value W, namely, (d₁+d₂)/W. The control unit 18 determines whether the ratio S calculated is smaller than the predetermined ratio.

When the ratio value S is smaller than the predetermined ratio, the control unit 18 remains displaying the current picture B on the window 100. When the ratio S is equal to or greater than the predetermined ratio, the control unit 18 further determines whether the time duration T calculated is smaller than a predetermined time period.

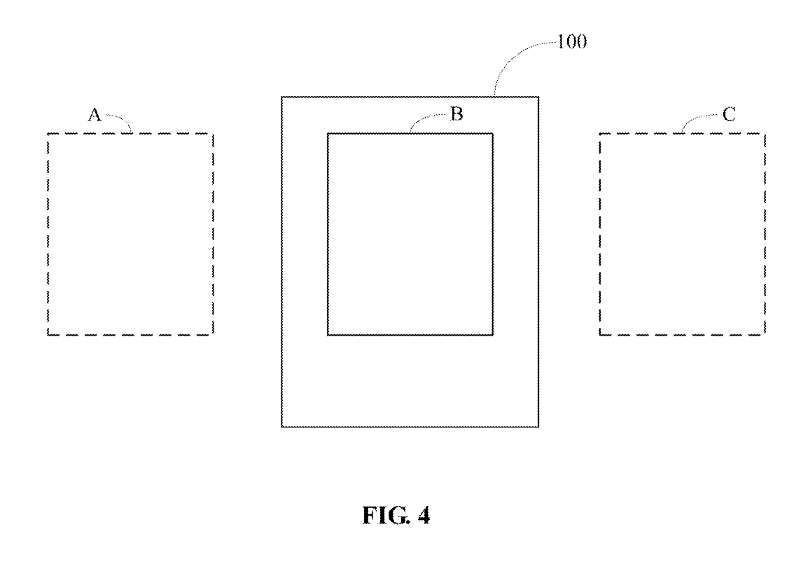

When the ratio S is equal to or greater than the predetermined ratio and the time duration T is smaller than the predetermined time period, the control unit 18 generates a picture reducing signal. The picture processing unit 17 reduces the current picture B in response to the picture reducing signal, and controls the display screen 12 to display only the reduced picture whose size is smaller than the size of the window 100 (as shown in FIG. 4).

When the ratio S is equal to or greater than the predetermined ratio and the time duration T is equal to or greater than the predetermined time period, the control unit 18 generates a picture changing signal. The picture processing unit 17 obtains the target picture from the storage unit 11 in response to the picture changing signal, and controls the display screen 12 to display only the target picture.

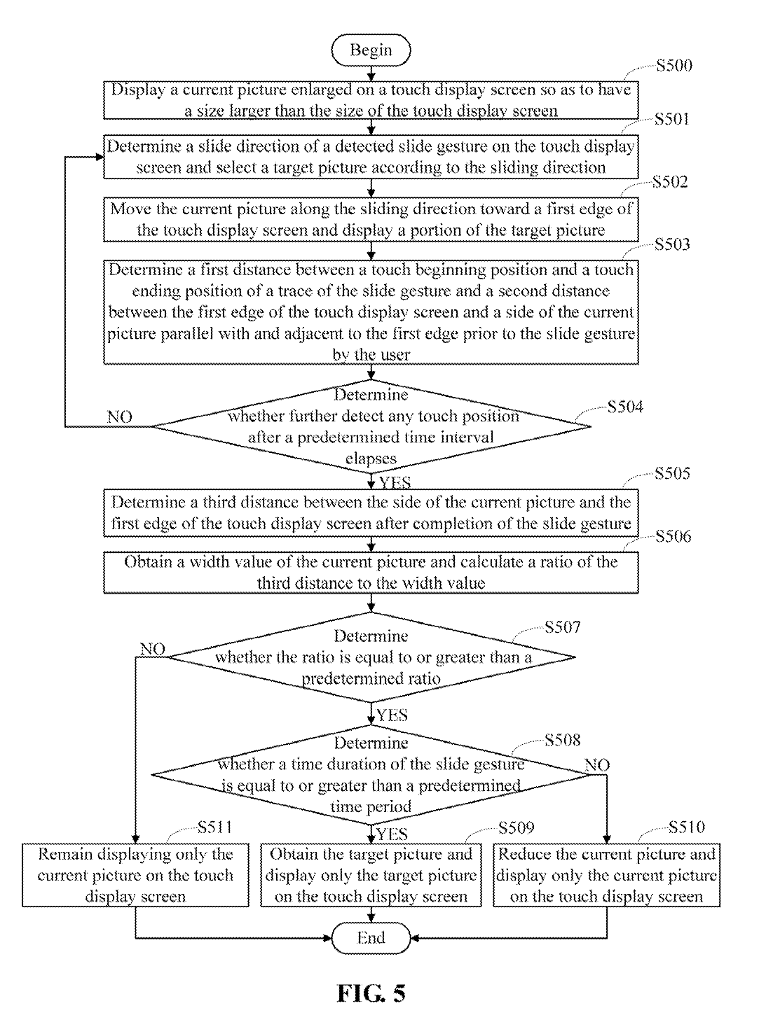

FIG. 5 shows a method capable of switching displayed pictures in response to slide gestures.

In step S500, the control unit 18 controls the display screen 12 to display the current picture on the display screen 12, the current picture being enlarged so as to have a size is larger than the size of the display screen 12, which results in portion of the current picture out of the display screen 12.

In step S501, the touch detecting unit 13 detects a slide gesture by a user on the display screen 12, and determines a sliding direction of the detected slide gesture. The touch determining unit 14 selects a target picture according to the determined sliding direction.

In detail, the touch determining unit 14 selects the target picture to be a picture before the current picture when the sliding direction is from left to right or from up to down. The touch determining unit 14 selects the target picture to be a picture next the current picture when the sliding direction is from right to left or from down to up.

In step S502, the picture processing unit 17 controls to move the current picture on the display screen 12 along the sliding direction toward a first edge 101 of the display screen 12 in response to the slide gesture, and displays a portion of the target picture on the display screen 12 in response to the slide gesture.

In step S503, the touch detecting unit 13 determines whether further detects any touch position after a predetermined time interval elapses, if yes, the procedure goes to step S504, otherwise, the procedure returns to step S501.

In step S504, the touch determining unit 14 determines the distance d₂ between a touch beginning position P and a touch ending position P′ of a trace of the slide gesture. The picture processing unit 17 determines the distance d₁ between the first edge 101 of the display screen 12 and a side of the current picture B parallel with and adjacent to the first edge prior to the slide gesture by the user.

The distance d₁ between the side of the current picture B and the first edge 101 of the window 100 is equal to the distance d₁ between the other side of the current picture B and the second edge 102 of the window 100.

In step S505, the picture processing unit 17 obtains width value W of the current picture B, and determines the distance D between the side of the current picture and the first edge of the display screen 12 after completion of the slide gesture.

In step S506, the calculating unit 15 calculates the ratio S of the distance D to the width value W.

In step S507, the control unit 18 determines whether the ratio S calculated is equal to or greater than a predetermined ratio. If yes, the procedure goes to step S508, otherwise, the procedure goes to step S511.

In step S508, the time calculating unit 16 calculates a time duration T of the slide gesture from the touch beginning position P to the touch ending position P′. The control unit 18 determines whether the time duration T calculated is equal to or greater than a predetermined time period, if yes, the procedure goes to step S509, otherwise, the procedure goes to step S510.

In step S509, the control unit 18 generates a picture changing signal. The picture processing unit 17 obtains the target picture from the storage unit 11 in response to the picture changing signal, and controls the display screen 12 to only display the obtained target picture. Then, the procedure ends.

In step S510, the control unit 18 generates a picture reducing signal. The picture processing unit 17 reduces the current picture in response to the picture reducing signal, and controls the display screen 12 to display only the reduced current picture.

In step S511, the control unit 18 remains displaying only the current picture B on the display screen 12.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus capable of switching displayed pictures in response to a slide gesture by a user, comprising:
a storage unit configured for storing a plurality of pictures;
a display screen configured for displaying a current picture in response to a user's touch, wherein the current picture is enlarged and has a size larger than the size of the display screen;
a touch detecting unit configured for detecting a slide gesture by the user on the display screen, and further determining a sliding direction of the detected slide gesture;
a touch determining unit configured for selecting a target picture from the pictures according to the determined sliding direction; and further determining a first distance between a touch beginning position and a touch ending position of a trace of the detected slide gesture;
a picture processing unit configured for controlling moving the current picture on the display screen along the sliding direction toward a first edge of the display screen in response to the slide gesture such that a portion thereof adjacent to the first edge is moved out of the display screen, and controlling moving a portion of the target picture into the display screen from an opposite second edge thereof along the sliding direction in response to the slide gesture; the picture processing unit further configured for obtaining a width value of the current picture, determining a second distance between the first edge of the display screen and a side of the current picture parallel with and adjacent to the first edge prior to the slide gesture by the user, and further determining a third distance between the first edge of the display screen and the side of the current picture after completion of the slide gesture;
a calculating unit configured for calculating a ratio of the third distance to the width value;
a time calculating unit configured for calculating a time duration of the slide gesture from the touch beginning position to the touch ending position; and
a control unit configured for generating a picture changing signal if the ratio calculated is equal to or greater than the predetermined ratio and the time duration is equal to or greater than a predetermined time period, and for controlling the picture processing unit to obtain the target picture and controlling the display screen to only display the obtained target picture.

2. The apparatus capable of switching displayed pictures in response to a slide gesture by a user as claimed in claim 1, wherein the control unit is further configured for controlling the display screen to only display the enlarged current picture if the ratio calculated is smaller than the predetermined ratio.

3. The apparatus capable of switching displayed pictures in response to a slide gesture by a user as claimed in claim 1, wherein the control unit is further configured for generating a picture reducing signal if the ratio calculated is equal to or greater than the predetermined ratio and the time duration is smaller than the predetermined time period for controlling the picture processing unit to reduce the current picture and controlling the display screen to only display the reduced current picture, the current picture is reduced and has a size smaller than the size of the display screen.

4. The apparatus capable of switching displayed pictures in response to a slide gesture by a user as claimed in claim 1, wherein the predetermined ratio is ½.

5. A method capable of switching displayed pictures in response to a slide gesture by a user comprising:
displaying a current picture on a touch display screen, the current picture being enlarged so as to have a size larger than the size of the touch display screen;
determining a slide gesture by a user on the touch display screen, determining a sliding direction of the detected slide gesture, and further selecting a target picture according to the determined sliding direction;
controlling the current picture to move along the sliding direction toward a first edge of the touch display screen, and displaying a portion of the target picture on the touch display screen in response to the slide gesture;
determining a first distance between a touch beginning position and a touch ending position of a trace of the detected slide gesture, and a second distance between the first edge of the touch display screen and a side of the current picture parallel with and adjacent to the first edge prior to the slide gesture by the user;
determining a third distance between the side of the current picture and the first edge of the touch display screen after completion of the slide gesture;
obtaining a width value of the current picture and calculating a ratio of the third distance to the width value;
determining whether the ratio calculated is equal to or greater than a predetermined ratio;
calculating a time duration of the slide gesture from the touch beginning position to the touch ending position if the ratio calculated is equal to or greater than a predetermined ratio, and determining whether the time duration is equal to or greater than a predetermined time period; and
generating a picture changing signal if the time duration is equal to or greater than a predetermined time period for obtaining the target picture and displaying only the target picture on the touch display screen.

6. The method as claimed in claim 5, wherein if the ratio calculated is smaller than the predetermined ratio value, the method further comprises:
remaining displaying only the enlarged current picture on the touch display screen.

7. The method as claimed in claim 5, wherein the predetermined ratio is ½.

8. The method as claimed in claim 5, wherein if the time duration is smaller than the predetermined time period, the method further comprises:
generating a picture reducing signal for reducing the current picture and displaying only the reduced current picture on the touch display screen, wherein the current picture is reduced and has a size smaller than the size of the touch display screen.
